(19) United States
(12) Patent Application Publication
(10) Pub. No.: US 2013/0112356 A1
(43) Pub. Date: May 9, 2013

(54) Temporary Partition System and Components for the Same

(71) Applicant: Steve Matthews, Kingsteignton (GB)

(72) Inventor: Steve Matthews, Kingsteignton (GB)

(73) Assignee: PLASLOC LIMITED, KINGSTEIGNTON (GB)

(21) Appl. No.: 13/292,822

(22) Filed: Nov. 9, 2011

(51) Int. Cl. E06B 5/00

(52) U.S. Cl. 160/229.1

(57) ABSTRACT

A temporary partitioning system is provided, the system comprising a plurality of partition components, each component being an elongate member having outer walls enclosing a substantially hollow interior and having a longitudinal axis, each component being releasably connectable to an adjacent member by a connection means, the connection means comprising a first connection member provided on a first component and a second connection member provided on a second component, in use the first and second connecting members connecting such that lateral movement between the first and second components is prevented, while allowing the first component to move along its longitudinal axis relative to the second component. A temporary partition formed from the components of the system is also provided.

The present invention relates to a temporary partition system and to components for the same. In particular, the present invention relates to a system for providing a temporary partition in areas undergoing construction and/or renovation work, such as workplaces, retail spaces and the like.

It is frequently necessary to carry out work, such as maintenance, construction or renovation work, in workplace areas, such as offices, retail premises and the like. If the work required is of a sufficient scale and time and resources allow, it is possible to close off the entire workplace area, to limit access and exposure to the work activities to those persons carrying out the work. However, in many situations, it is preferred or required to maintain operations within the workplace area while the work is being carried out. For example, it may be required to refit or renovate a portion of an office workspace, while still allow office personnel to carry out their normal duties in an adjacent or adjoining area. In such a case, it is necessary to separate the office personnel from the work being carried out. Similarly, it is very common that retail premises undergo a modernisation or refit from time to time. While it would be preferable to close the entire retail operation until such work has been fully completed, it is often necessary to allow the retail operations to continue while work is still underway. In such a case, it is essential to separate customers of the retail operation from the work area.

In such cases, it is well known to construct partitions between the areas in which maintenance work, construction work and the like are being carried out and areas where other activities are to be continued, such as office work or retail operations. Such partitions are constructed and erected on a temporary basis. The partitions are typically constructed from timber and sheet materials, such as plywood, fibre board and the like. The partitions are constructed in a bespoke manner, to fit the particular space in which they are required. This leads to a number of significant problems. First, the partitions are frequently required to be moved during the work process, for example as a refit or renovation progresses through a floor or building. The manner in which the partitions are constructed and erected does not lend them to be easily dismantled, moved and re-erected. Rather, it is frequently the case that the partitions are partially or even wholly dismantled and rebuilt from new. In most cases, this involves the use of fresh timber and materials, with significant portions of the existing partition being unused and discarded. Second, when the work is completed and the partitions are no longer required, they are dismantled and the entire partition is discarded. Typically, the materials of the partition are disposed of by way of land-fill. As will be appreciated, this represents a significant waste of materials that can be reused. Further, such building activities contribute significantly to the volume of waste materials being disposed of, in particular by way of land-fill.

Accordingly, there is a need to provide an improved system for constructing temporary partitions in the aforementioned workspaces. It would be particularly advantageous if the system would allow the components of the partition to be adjusted to fit a variety of different spaces. It would also be of advantage if the components of the system could be dismantled and reused, with the minimum of waste being formed.

According to the present invention, there is provided a temporary partitioning system, the system comprising a plurality of partition components, each component being an elongate member having outer walls enclosing a substantially hollow interior and having a longitudinal axis, each component being releasably connectable to an adjacent member by a connection means, the connection means comprising a first connection member provided on a first component and a second connection member provided on a second component, in use the first and second connecting members connecting such that lateral movement between the first and second components is prevented, while allowing the first component to move along its longitudinal axis relative to the second component.

The system of the present invention is versatile and allows the components to be assembled to fit a particular space, disassembled and reassembled to form a new or modified partition in the same space. In this way, substantially the same components may be used to modify the partition, as work progresses through the work space. Further, once work has been completed, the entire partition may be removed and the components reused, with little or no waste. As will be described in more detail below, the components of the system may be formed from recycled materials, using commonly available and well known techniques.

The system of the present invention comprises a plurality of components which, when connected to one another, form a partition. Depending upon the particular components employed, the partition may be provided with one or more door openings and/or one or more window openings. It is a particular advantage of the system that the position of the door and window openings may be selected to suit the particular space in which the work is being conducted and the needs of the work, for example to provide access to workmen and their equipment.

The system comprises a plurality of components. Each component is generally elongate and has a longitudinal axis. In use, each component is arranged to have its longitudinal axis extending vertically or substantially vertically.

Each component of the system is hollow or substantially hollow. The space within the component is preferably fully enclosed, with the exception of the longitudinal ends of the component, which may be left open. Such a construction provides the component with strength and rigidity, while allowing the component to be easily formed. The components may be formed from any suitable material, for example metal and plastic. It is particularly preferred, and advantageous, that the components of the system are formed from plastic. Any suitable plastic or blend of plastics may be used. Preferably, the components are formed from a thermoplastic. Examples of suitable plastics include polyolefins, for example polyethylene and polypropylene and blends thereof, and polyvinyl chloride (PVC).

The components may be formed by any suitable technique. It is particularly preferred that each component is formed by extrusion and the construction and form of each component of the system has been designed to allow the components to be formed by extrusion. A particularly preferred component is one prepared from extruded plastic.

As noted above, the components of the system may be formed from virgin materials. However, it is particularly preferred that the components are formed at least in part, preferably wholly, from recycled materials. Again, forming the components by extrusion from plastic allows the use of recycled plastics. In particular, it has been found that the components of the system of the present invention when prepared from extruded plastic can be recycled and the plastic material used to prepare new components for use again in the system of the present invention. In this way, broken or damaged components that arise through the use of the system can be recycled and their plastic reused. In this way, the amount of waste material produced by the system of the present invention is kept to a minimum.

The components of the system of the present invention are provided with means to allow the components to be releasably connected to one another, in order to assembly and create the partition. Thus, a partition is formed from the connecting together of a plurality of the components of the system. The means for connecting adjacent components of the system are such that the adjacent components may be moved longitudinally with respect to one another. In this way, the components may be connected together to fit the space in which the partition is being assembled. The means for connecting adjacent components further substantially prevents lateral movement of one component with respect to the other. In this respect lateral movement is a reference to movement of one component with respect to the adjacent component in a direction perpendicular to the longitudinal axis of the components.

The means for releasably connecting the components of the system comprise a first connecting member and a second connecting member. The first connecting member is provided on a first component and the second connecting member is provided on a second component. In use, to connect the first and second components, the first connecting member is engaged with the second connecting member. Preferably, each component is formed with means to releasably connect with each of two adjacent components, the means being provided on different or opposing sides or edge portions of the component. In this case, each component may be provided with two first connecting members or two second connecting members, each on different or opposing sides or edge portions of the component. Most preferably, however, each component is provided with a first connecting member on one surface or edge portion and a second connecting member on a different or opposing surface or edge portion.

The releasable connection means may comprise any suitable, cooperating connecting members. In one embodiment, the first and second connecting members are male and female members, respectively. In use, the male member is received within the female member and held therein. The releasable connection means are provided in an outer wall or edge portion of the component, that is an outer wall is provided with a first or second connecting member. A given outer wall or edge portion of a component may be provided with one or a plurality of such means for connecting the component to an adjacent component. In a preferred embodiment of the present invention, the wall or edge portion is provided with a single releasable connection means for connecting the component with an adjacent component, that is the connection between two adjacent components is formed using a single releasable connection means.

Each component may be provided with the releasable connection means extending along part of the length of the component. Preferably, each releasable connection means extends along the majority of the length of the component, more preferably along substantially all or the entire length of the component. In this way, each component may be releasably connected along one surface or edge portion to one or more adjacent components by a single connection means extending along the entire length of the component.

As noted, the releasable connection means comprises a first connecting member provided on a first component and a second connecting member provided on a second component. As noted, in one preferred embodiment, in use, the first connecting member is inserted into the second connecting member, to form the releasable connection. In a preferred arrangement, the first connecting member is an interference fit within the second connecting member, thereby forming a connection of sufficient strength and rigidity. One or both of the first and second connecting members is preferably resilient, providing surfaces of the first and/or second connecting member with a biasing force, the first connecting member being inserted into the second connecting member against this bias. The bias further aids to hold the first connecting member within the second connecting member, once inserted. Any such bias present in either the first or second connecting members should not prevent the adjacent connection components from being moved longitudinally with respect to each other. However, such a bias is preferably sufficient to prevent such longitudinal movement of the components without a longitudinal force being applied to one of the components.

The first and second connecting members may be formed with any suitable cooperating forms. As noted, the first connecting member is preferably a male member and the second connecting member is a female member, arranged to receive and hold the male member. In a preferred arrangement, the male member is a tongue extending longitudinally along and from one surface or edge portion of a first member. The female member comprises a corresponding recess or groove provided in and extending longitudinally along a surface or edge portion of a second member, in use the tongue being inserted into the groove to form the releasable connection. In a preferred arrangement, the tongue has the portion distal of the component with a larger cross-sectional dimension than a portion proximal the component. The corresponding groove is preferably formed with an elongate opening having a width approximately the same as the cross-sectional dimension of the proximal portion of the elongate member, with the width of the interior of the groove being approximately the same as the cross-sectional dimension of the distal portion of the tongue. In this way, the elongate opening of the groove is required to be widened to accept the distal portion of the tongue. By having the female member formed of a resilient material or construction, the male member is thereby held in the female member. If the width of the elongate opening of the groove is larger than the cross-sectional dimension of the proximal portion of the tongue, the bias of the female member causes the tongue to be firmly gripped and held within the groove.

The ratio of the dimension of the distal portion to the dimension of the proximal portion of the male member is selected to allow the male member to be inserted into and removed from the female member, while still ensuring the male member is firmly held by the female member, when engaged. The ratio will depend upon such factors as the materials of construction, the resilience of the male and female members and the wall thickness of the components, and may be in the range of from 1:1.01 to 1:1.3, preferably from 1:1.05 to 1:1.25, more preferably from 1:1.1 to 1:1.25.

The components of the system may be provided with releasable connection means having first and second connecting members that are of one size. In this way, there is a very high degree of interchangeability between components and a large number of possible ways to connect components. This in turn increases the versatility of the system. If desired, the system may be provided with releasable connection means of different sizes. For example, a first, smaller releasable connection means may be provided to connect components that are not subject to high loads or forces in the assembled partition. Examples of such low load components are the components that form the major planar or curved surfaces of the partition. For components subjected to higher loads, for example components forming posts, frames for openings, such as doors or windows, and the like, a releasable connection of larger dimensions may be provided. In particular, the first connecting members, such as the aforementioned tongues, may be provided either with a first, smaller dimension, or with a second, larger dimension. The ratio of the dimensions of the first and second male member may be in the range of 1:2 to 1:20, more preferably from 1:5 to 1:10. The second connecting members, for example the grooves described above, to accommodate the first connecting members are similarly sized. The system may be provided with releasable connection means in three or more different sizes, on the same principle. However, the options for interconnecting the components will be reduced.

In a preferred embodiment, the system comprises releasable connection means of two different dimensions, that is first connecting members may be one of two different dimensions. Some or all components are provided with second connecting members that can accommodate either of the two sizes of first connecting members. In this way, the reduction in versatility of the system by having two different sizes of connection means is at least partially removed.

The releasable connection means for connecting adjacent components of the system comprise a first connecting member and corresponding second connecting member. Both the first connecting member and the second connecting member may be provided as integral parts of respective components to be connected, for example in the form of the tongue and groove described above. Alternatively, one or both of the first and second connecting members may be provided as separate connecting members from the components of the system. In this case, the components are connected by first attaching a first connecting member to one component and a second connecting member to a second component. The provision of first and second connecting members separate from the components of the system also allows for a greater freedom in connecting the components. Thus, a separate first connecting member, for example an elongate tongue member having two opposing tongues of the aforementioned kind, allows two components both having second connecting members to be connected together directly. Similarly, a separate second connecting member, for example provided with opposing elongate grooves therein, may be used to connect the first connecting members of two components. It follows that a mixed separate first/second connecting member may also be provided, having a first connecting member and opposing second member thereon.

Further, a separate first connecting member of the aforementioned kind, in particular a male connecting member may be formed from a flexible, resilient material, for example a soft plastic or rubber. In such a case, one portion of the male connecting member may be inserted into a corresponding female member, for example integrally formed in a component. The second portion of the male connecting member extends from the component and may be used to contact and hold a component, such as a glass panel or the like. As the male connecting member is flexible, the component being held can be arranged to partially crush or deform the male connecting member, thus being held by the resilient material more firmly.

As noted above, the components of the system are elongate, that is have a length that is many times greater than the largest lateral dimension of the component. The components may be formed in any suitable length. For example, the components may be formed into lengths in the range of from 1 to 5 metres, more preferably from 2 to 4 metres. The components may each be of a length to extend the entire required height of the partition, for example from the floor to the ceiling of a space, in the case that the partition is to entirely enclose a particular space or area. Alternatively, two or more components may be combined longitudinally to extend to the required height. Means for combining components in this way are described below. The general form and construction of the components allows them to be easily cut to length, if required.

The outer walls of each component are preferably continuous and fully enclose the hollow or substantially hollow interior of the component, with the exception of the open ends of the component. The outer walls may have any suitable thickness, determined by such factors as the overall dimensions of the component and its material of construction. Typically, the wall thickness is in the range of from 0.5 mm to 5.0 mm, more preferably from 0.75 mm to 3.0 mm, still more preferably from 1.0 to 2.0 mm. Partitions and/or ribs present within the component may have any suitable thickness, sufficient to provide the required support and rigidity to the outer walls and the component as a whole. Again, the wall thickness will be determined by such factors as the material of construction and the overall dimensions of the component. Typically, the thickness of any ribs and partitions is in the range of from 0.3 mm to 4.0 mm, more preferably from 0.5 mm to 3.0 mm, still more preferably from 0.5 to 1.5 mm.

The components of the system of the present invention may be of a variety of forms, depending upon the function of the component within the partition. In general, the components have a cross-sectional shape that is rectangular or square, or comprised of two or more rectangular and/or square portions. As noted, the components are formed with a hollow interior. The interior of the component may be completely empty. Components with a relatively small cross-sectional area may be formed with sufficient strength and rigidity with an entirely empty or hollow interior. Alternatively, the interior of the component may be provided with one or more ribs and/or partitions extending longitudinally, preferably the entire length of the component. Such ribs and/or partitions provide the components with increased strength and rigidity, especially torsional rigidity, and are particularly preferred for components with a relatively large cross-sectional area and/or for components required to perform a structural role, for example a frame for an opening such as a door or window. The ribs and/or partitions may extend at any suitable angle across the interior of the component. Preferably, any ribs or partitions present extend substantially perpendicular to the outer walls of the component.

Typically, the system comprises a plurality of panel components. Each panel component is as hereinbefore described, that is, is elongate with a hollow or substantially hollow, enclosed interior, optionally open at each longitudinal end. A panel component is characterised by having a pair of major, opposing, parallel walls and a pair of minor, opposing walls extending substantially perpendicular between the major opposing walls. Releasable connection means are provided on each minor opposing wall for connecting the component to two adjacent components. Preferably, one of the minor opposing walls is provided with a male member and the other minor opposing wall provided with a female member. Other arrangements of the male and female connecting members are also possible, however. In use, adjacent components are connected with their minor opposing walls facing and the major opposing walls of the connected components forming the major surfaces of the partition.

The major opposing walls of the panel component may be substantially flat. When assembled into a partition, such panel components form the major planar surfaces of the partition. Alternatively, the major opposing walls of the panel component may be arcuate or curvilinear, in particular curved in a plane parallel to the longitudinal axis of the component. Such panel components may be incorporated into the partition to form curvilinear surfaces. If curved, the radius of curvature may be any desired radius of curvature, but is typically in the range of from 5 to 50 cm, preferably from 10 to 30 cm, more preferably from 15 to 25 cm.

The panel components may be formed with a cross-section of any suitable dimensions. The panel components have a cross-section that is generally rectangular. The cross-section may have an aspect ratio of from 1 to 20, preferably from 2 to 15, more preferably from 5 to 10. Panel components with a cross-section having a larger aspect ratio, in particular greater than 5, are preferably provided with one or more longitudinal partitions extending within the interior, most preferably extending perpendicular to the major opposing walls of the component.

The system may comprise one or more corner post components. The corner post components allow two adjacent panels comprising a plurality of panel components to be assembled and connected at an angle to each other. Each corner post component is as hereinbefore described, that is, is elongate with a hollow or substantially hollow, enclosed interior, optionally open at each longitudinal end. A corner post component is characterised by having a first outer wall and a second outer wall, the second outer wall extending at an angle, preferably perpendicular, to the first outer wall. The first and second outer walls are preferably adjacent walls. Releasable connection means are provided on each of the first and second outer walls for connecting the component to two adjacent components, the two adjacent components when connected extending at an angle, preferably perpendicular, to one another. Preferably, one of the outer walls is provided with a male member and the other outer wall provided with a female member. Other arrangements of the male and female connecting members are also possible, however.

The corner post components may be formed with a cross-section of any suitable dimensions. The panel components have a cross-section that is generally rectangular or square. The interior of the corner post component may be entirely hollow. However, larger corner post components are preferably provided with one or more longitudinal partitions extending within the interior, most preferably extending perpendicular to the first or second outer walls of the component.

The partition, when assembled, may require one or more post assemblies of a larger cross-section dimension that can be formed using a single corner post component. Accordingly, the system may comprise post side components. The post side components are arranged to be connected together and/or to other components, such as panel components or corner post components, to form a vertical post for the partition.

Typically, the system comprises a plurality of post side components. Each post side component is as hereinbefore described, that is, is elongate with a hollow or substantially hollow, enclosed interior, optionally open at each longitudinal end. A post side component is characterised by having a pair of major, opposing, parallel walls and a pair of minor, opposing walls extending substantially perpendicular between the major opposing walls. Releasable connection means are provided in each minor opposing wall for connecting the component to two adjacent components. Preferably, one of the minor opposing walls is provided with a male member and the other minor opposing wall provided with a female member. Other arrangements of the male and female connecting members are also possible, however. Further, one or more releasable connection means, either male or female members are provided in one or both of the major opposing walls. In use, the post side components are connected together and/or to other components, in particular in combination with corner post components to form post assemblies for the partition.

The major opposing walls of the post side component may be substantially flat. Alternatively, the major opposing walls of the post side component may be arcuate or curvilinear, in particular curved in a plane parallel to the longitudinal axis of the component. If curved, the radius of curvature may be any desired radius of curvature, but is typically in the range of from 5 to 50 cm, preferably from 10 to 30 cm, more preferably from 15 to 25 cm.

The post side components may be formed with a cross-section of any suitable dimensions. The post side components have a cross-section that is generally rectangular. The cross-section may have an aspect ratio of from 1 to 20, preferably from 2 to 15, more preferably from 3 to 10. Due to their structural role in an assembled partition, post side components with a cross-section having a relatively large aspect ratio, in particular greater than 2, are preferably provided with one or more longitudinal partitions extending within the interior, most preferably extending perpendicular to the major opposing walls of the component.

As noted above, the components of the system may be provided with releasable connection means of different sizes. One preferred arrangement of the post side component is to provide one or both of the minor opposing walls with a releasable connection means of a first, smaller dimension, and to provide one or both of the major opposing surfaces with a releasable connection means of a second, larger dimension.

To allow the partition to be provided with one or more openings, in particular door and/or window openings, the system may be provided with frame components for forming openings. Such frame components are as hereinbefore described, that is, are elongate with a hollow or substantially hollow, enclosed interior, optionally open at each longitudinal end. The cross sectional form of the frame components will be determined by the function and form of the opening to be provided in the partition, for example to accommodate a door or a window. The frame components are provided with releasable connection means in at least one outer wall that faces away from the opening, for example parallel to the plane of the opening or perpendicular thereto. Preferably, the outer walls of the frame components that are intended to face the opening in the partition are not provided with connection means.

The frame components may take any suitable form in cross-section to accommodate such items as doors and windows. In general, the frame components will have cross-sections that are rectangular or formed with two or more rectangular portions. As the frame components are generally load bearing components in the assembled partition, they are preferably provided with partitions extending within and across the interior of the components, to provide rigidity and strength to the components, in particular torsional rigidity.

The system of the present invention may be arranged to accommodate existing window and door assemblies. In one preferred embodiment, doors to be provided in openings in the partition are assembled from components of the system, in particular one or a plurality of panel components. A particularly preferred embodiment of the system comprises a door hinge component, having the general form and configuration of a panel component as described above, but having a releasable connection means in only one of the minor opposing walls. The other minor opposing wall is arranged to provide a mounting for a hinge or other means to hang the door in the opening from the frame component.

As noted above, the components of the system of the present invention are substantially or wholly hollow. If desired, some or all components may be partially or wholly filled with a material, for example a sound or heat insulating material and/or a fire retardant material. More preferably, the components of the system are arranged to allow part or all of the partition to formed as a cavity wall. That is, the components are arranged to form an inner wall and an outer wall, spaced from the inner wall, with a cavity defined therebetween. The cavity may be filled with suitable materials, such as sound or heat insulating materials and/or fire retardant or resistant materials. To facilitate the construction of a cavity wall, the system preferably comprises a cavity end component. The cavity end component is similar in general construction to the post side components described above. Thus, each cavity end component is as hereinbefore described, that is, is elongate with a hollow or substantially hollow, enclosed interior, optionally open at each longitudinal end. A cavity end component is characterised by having a pair of major, opposing, parallel walls and a pair of minor, opposing walls extending substantially perpendicular between the major opposing walls. Releasable connection means are provided in both edge portions of a first of the major opposing walls. Preferably, one of the edge portions is provided with a male member and the other edge portion provided with a female member. Other arrangements of the male and female connecting members are also possible, however. In use, panel components may be connected to each edge portion of the first major opposing wall and extend perpendicular therefrom, the panel components being spaced apart to form a cavity therebetween, with the end of the cavity defined by the first major face of the cavity end component. Further, one or more releasable connection means, for example either male or female members, are provided in the second major opposing wall.

As noted above, the components of the system may be provided with releasable connection means of different sizes. One preferred arrangement of the cavity end component is to provide the first major opposing wall with releasable connection means of a first, smaller dimension, for connection to a panel component, and to provide the second major opposing wall with one or more releasable connection means of a second, larger dimension.

The major opposing walls of the cavity end component may be substantially flat. Alternatively, the major opposing walls of the cavity end component may be arcuate or curvilinear, in particular curved in a plane parallel to the longitudinal axis of the component. If curved, the radius of curvature may be any desired radius of curvature, but is typically in the range of from 5 to 50 cm, preferably from 10 to 30 cm, more preferably from 15 to 25 cm.

The cavity end components may be formed with a cross-section of any suitable dimensions. The cavity end components have a cross-section that is generally rectangular. The cross-section may have an aspect ratio of from 1 to 20, preferably from 2 to 15, more preferably from 3 to 10. Due to their structural role in an assembled partition, cavity components with a cross-section having a relatively large aspect ratio, in particular greater than 2, are preferably provided with one or more longitudinal partitions extending within the interior, most preferably extending perpendicular to the major opposing walls of the component.

The system of the present invention may be provided with further components, as required for a completed partition. For example, components may be provided to provide trunking for cables, pipes, and the like. Such trunking components may extend vertically or horizontally along the partition, when in use.

Similarly, components may be provided to provide support for such items as blinds, flexible covers, sheets, lighting or the like. Such components are preferably provided with releasable connection means of the same form as those of the components forming the partition.

The partition formed from the components of the system of the present invention may be secured to the structure of the building in which it is being used, for example to the floor, walls and/or ceiling, using conventional means. However, to allow the partition to be partially or wholly free-standing, the system may comprise one or more base components. The base components extend across the floor on which the partition is erected and preferably comprise a base plate. To provide additional support for the structure, the base plate may be adapted to have weights placed thereon. A preferred form of weight for use on the base plates is a container for holding water.

As noted above, the components of the system generally extend vertically from the floor to form the partition. As also noted, the components may be sized or cut to fit the space provided or the desired height of the partition. However, to allow components to be connected longitudinally, the system preferably comprises one or more extension components. Each extension component is an elongate component arranged to be a close fit within the interior of some or all of the aforementioned components. The extension component comprises a plurality of lateral members, such as walls, that, when in use, extend across the interior of the component into which the extension component has been inserted and contact and bear against the inner surface of the walls and/or, if present, partitions of the component, thereby forming an interference fit between the extension component and the interior of the component into which it is inserted.

In use, the extension component may have a first portion extending into a first component and a second portion extending into a second component, thereby connecting the first and second components longitudinally. A further effect of the presence of an extension component within the interior of a component is to increase its strength and rigidity, in the same way as the partitions and ribs described above. Accordingly, components requiring additional strength or rigidity may have an extension component inserted therein.

In a further aspect, the present invention provides a partition formed from components of the system hereinbefore described.

Embodiments of the present invention will now be described, by way of example only, having reference to the accompanying drawings, in which:

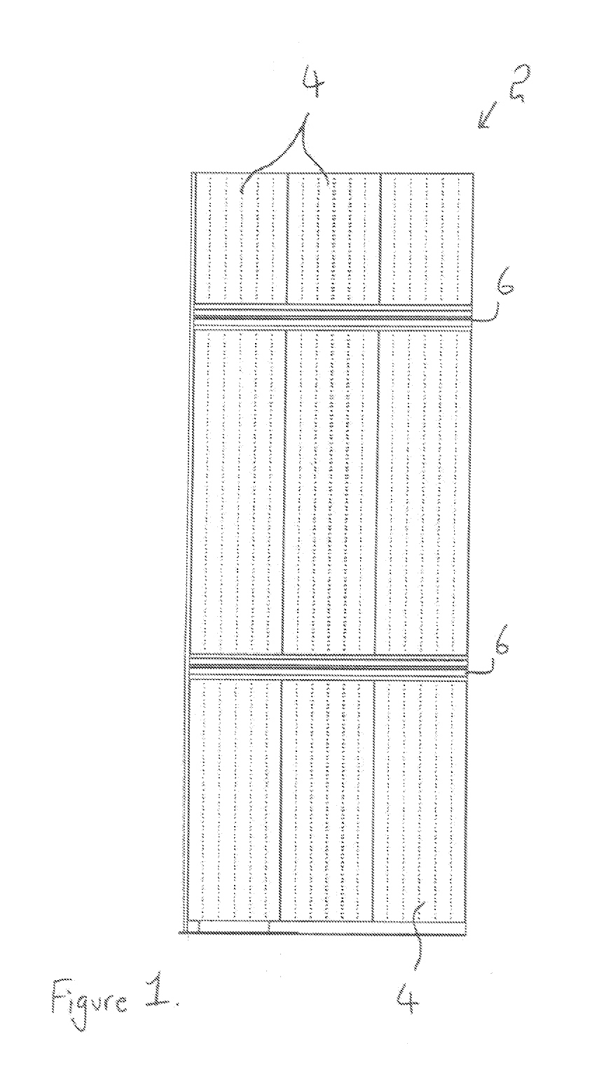

FIG. 1 is a front view of a partition formed using components of the system of the present invention;

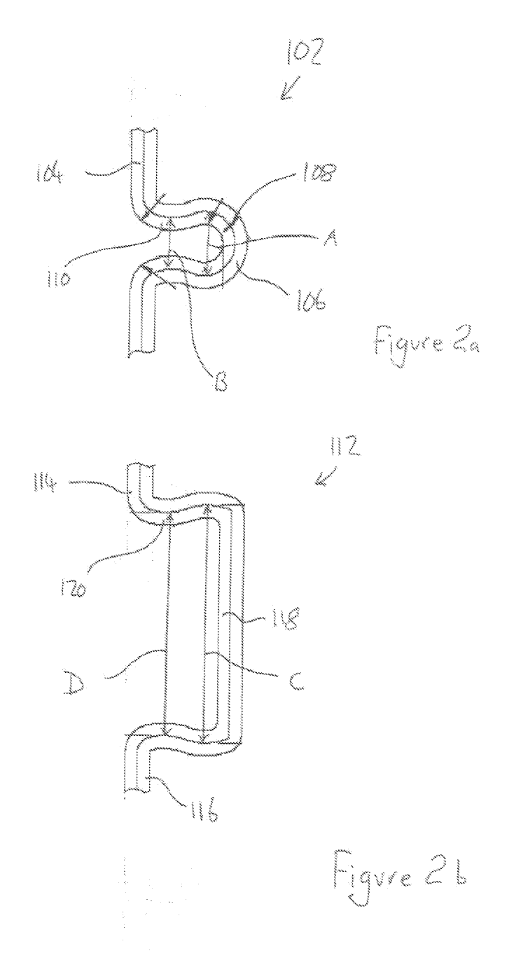

FIG. 2a is a cross-sectional view of male and female members of a first embodiment of a releasable connection means for connecting adjacent components of the system of the present invention;

FIG. 2b is a cross-sectional view of male and female members of a second embodiment of a releasable connection means for connecting adjacent components of the system of the present invention;

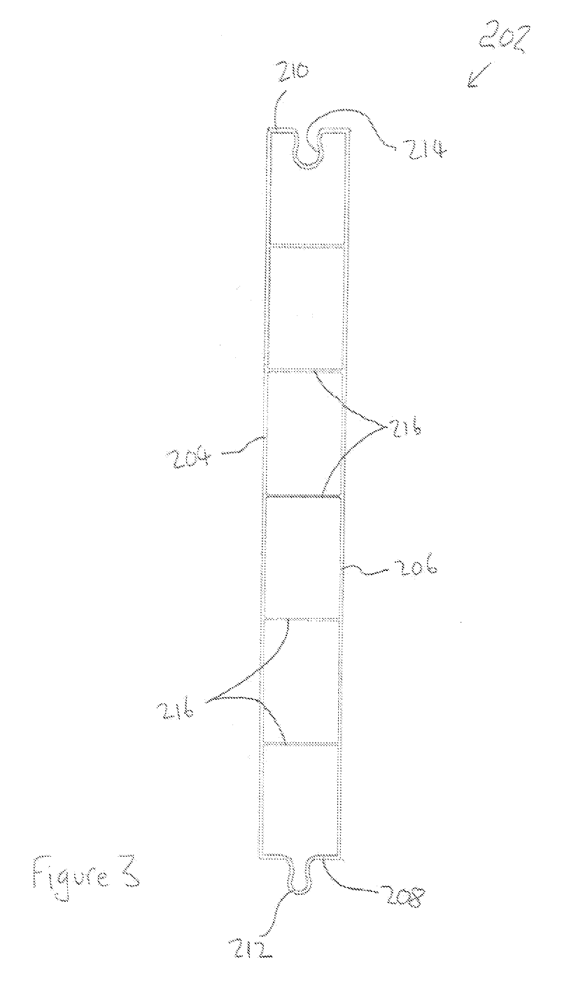

FIG. 3 is a cross-sectional view of one embodiment of a panel component of the system of the present invention;

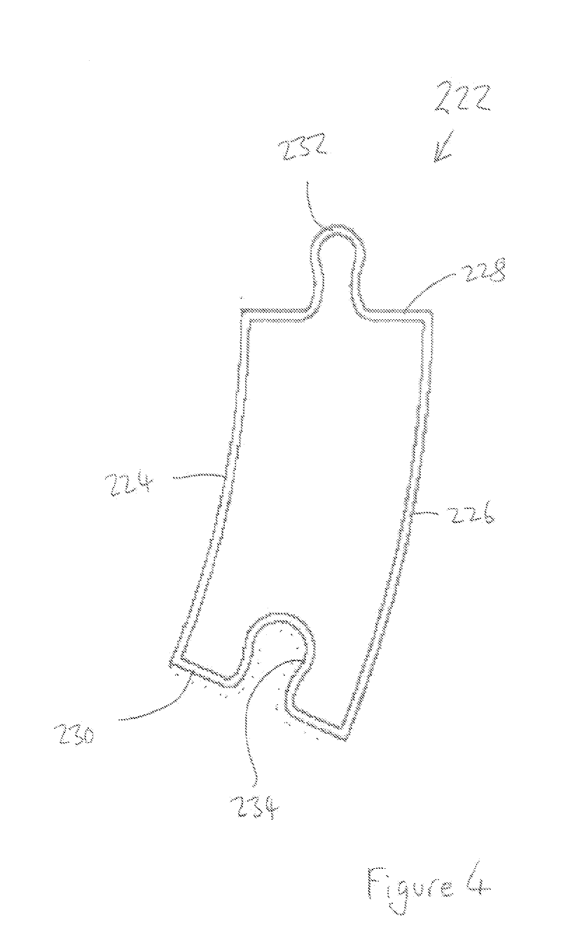

FIG. 4 is a cross-sectional view of a second embodiment of a panel component of the system of the present invention;

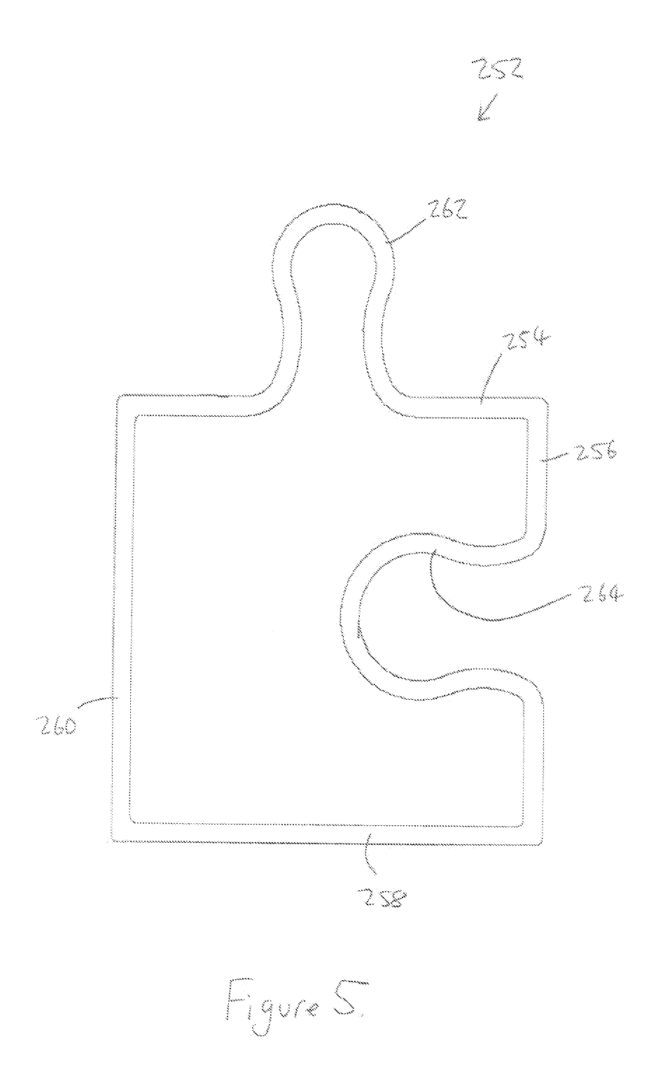

FIG. 5 is a cross-sectional view of a corner post component of one embodiment of the system of the present invention;

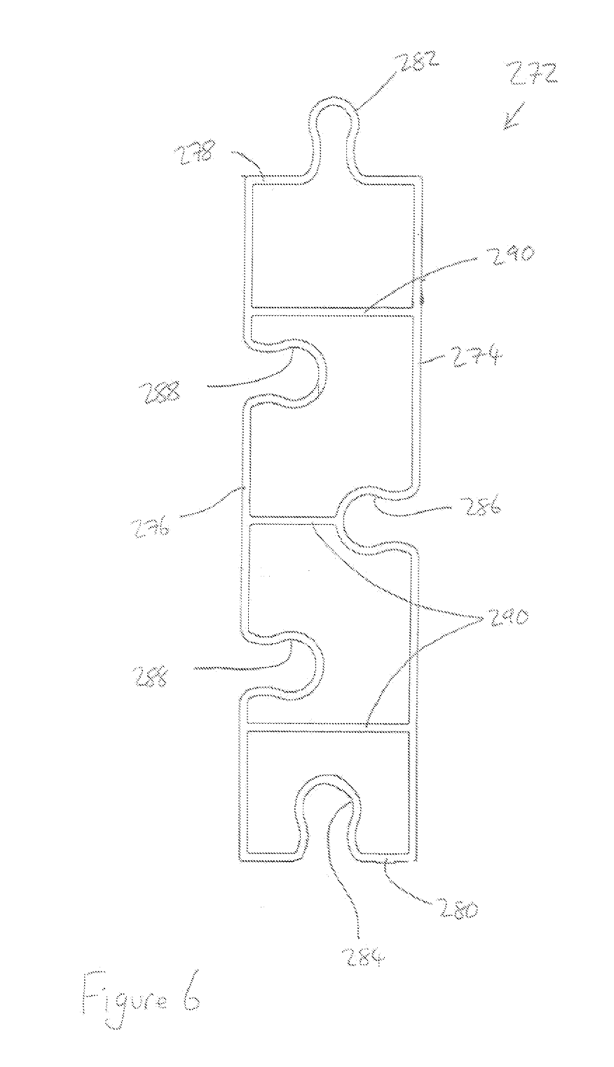

FIG. 6 is a cross-sectional view of one embodiment of a post side component of the system of the present invention;

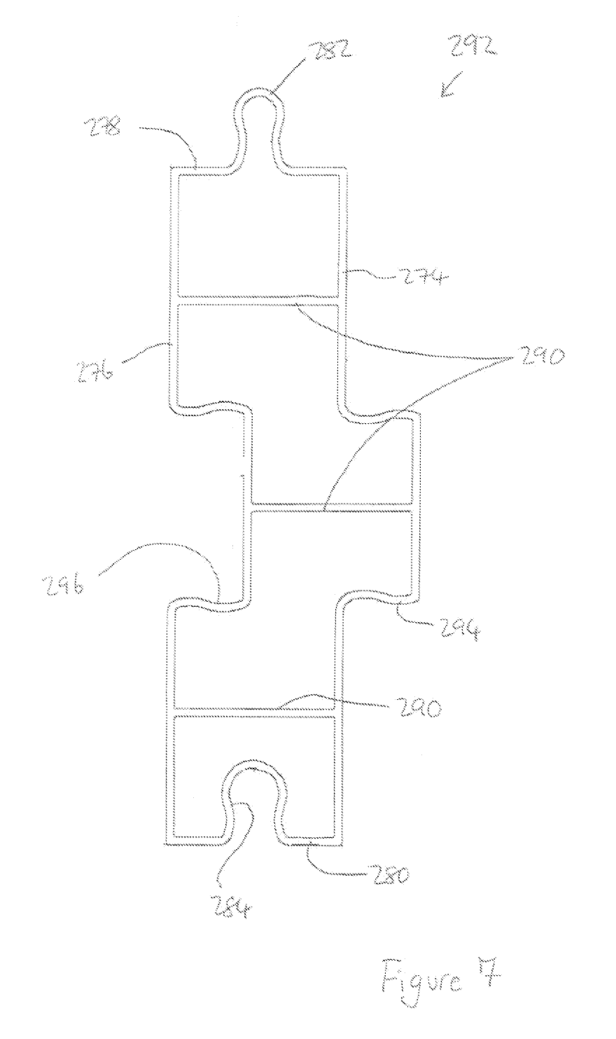

FIG. 7 is a cross-sectional view of a second embodiment of a post side component of the system of the present invention;

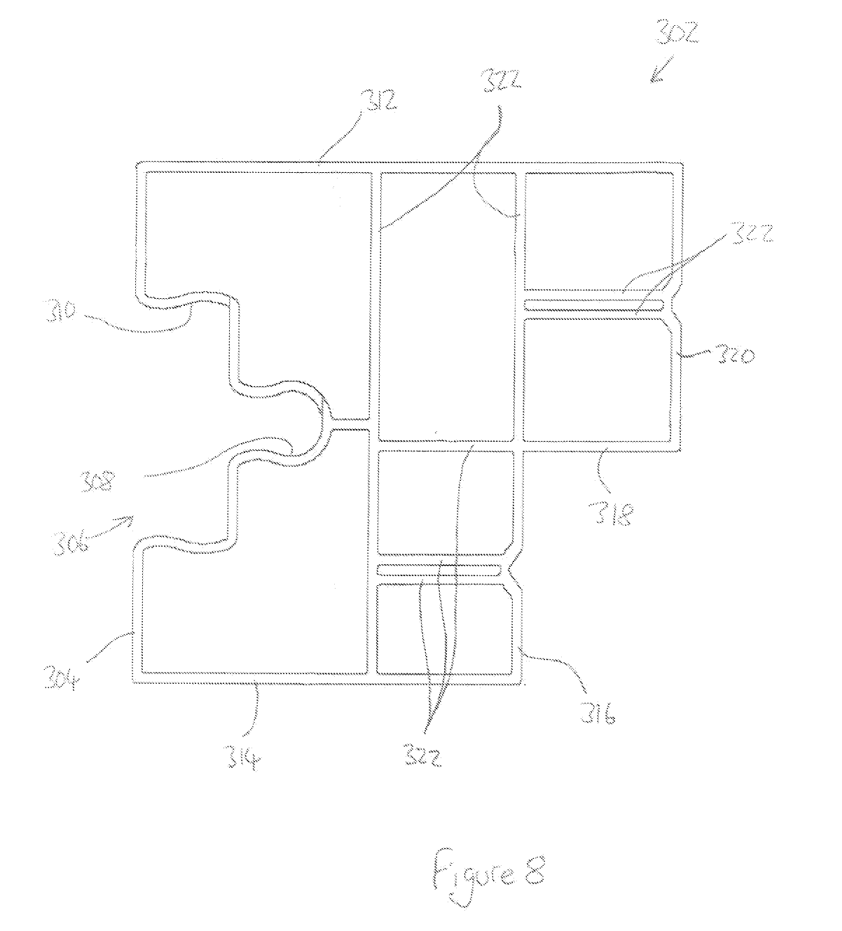

FIG. 8 is a cross-sectional view of one embodiment of a frame component of the system of the present invention;

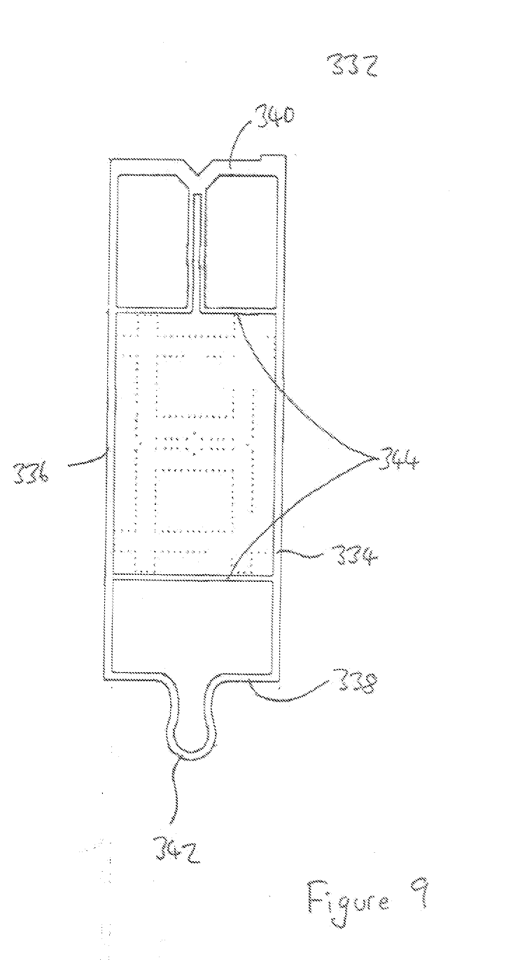

FIG. 9 is a cross-sectional view of one embodiment of a component of the system of the present invention for forming a door;

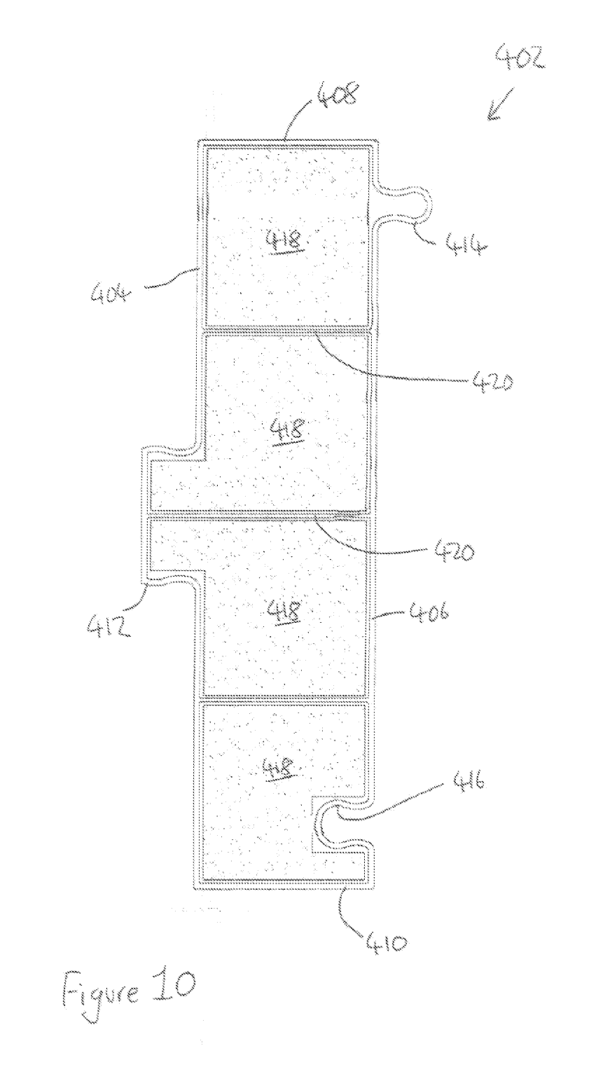

FIG. 10 is a cross-sectional view of one embodiment of a cavity end component of the system of the present invention;

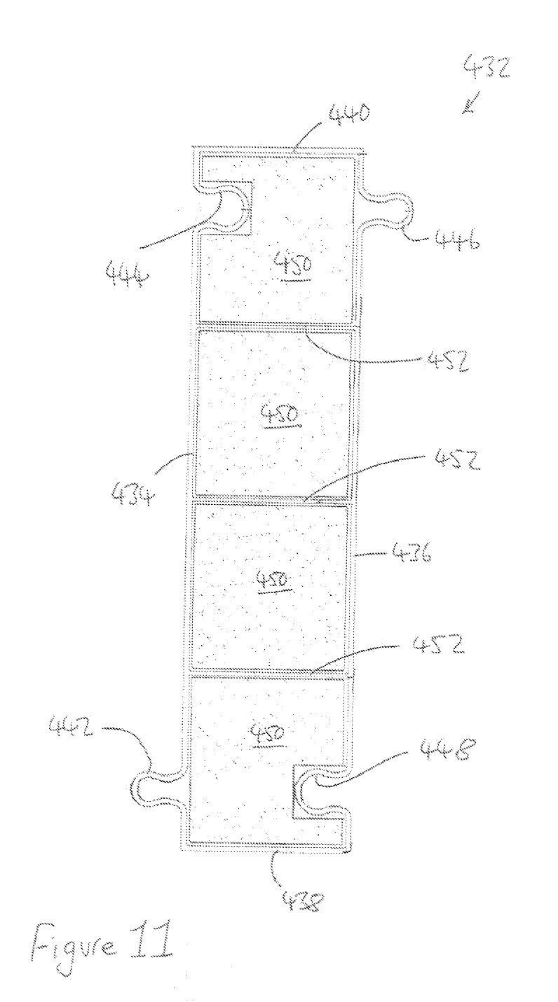

FIG. 11 is a cross-sectional view of a second embodiment of a cavity end component of the system of the present invention;

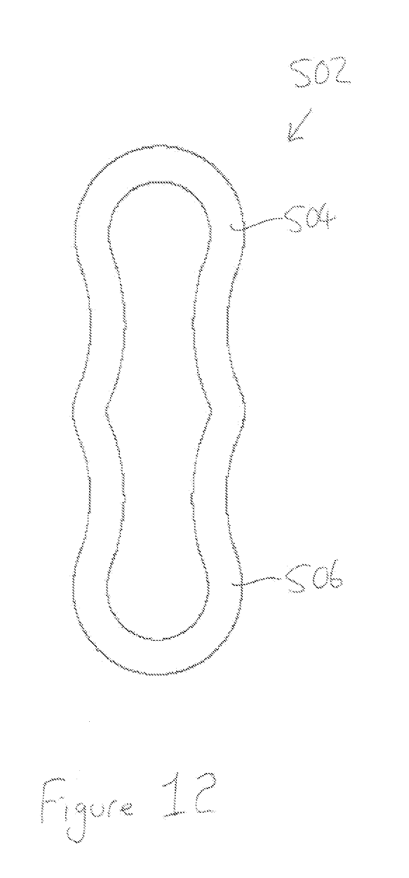

FIG. 12 is a cross-sectional view of a separate connecting member for use in connecting components of the system of the present invention;

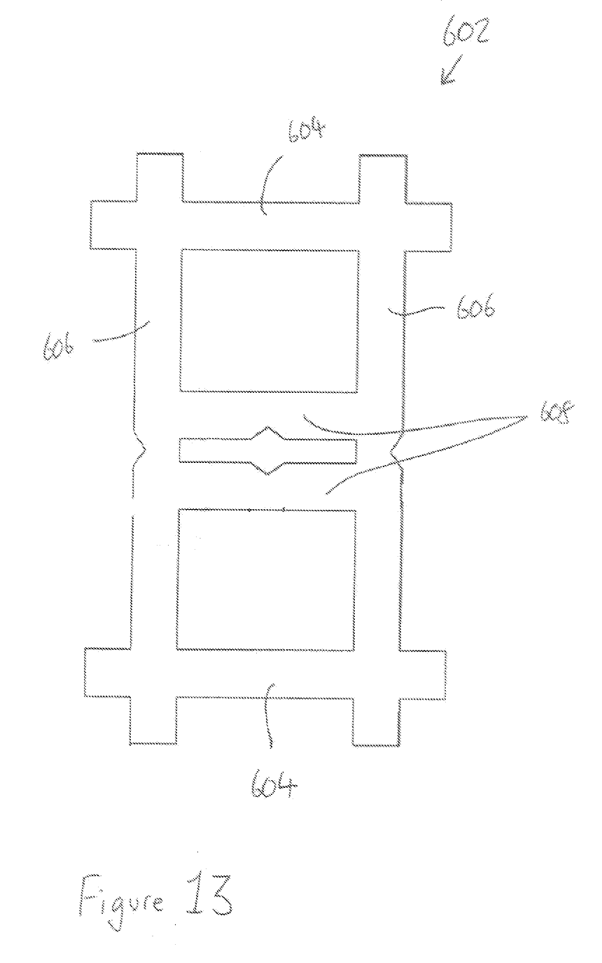

FIG. 13 is a cross-sectional view of one embodiment of an extension component for use with components of the system of the present invention;

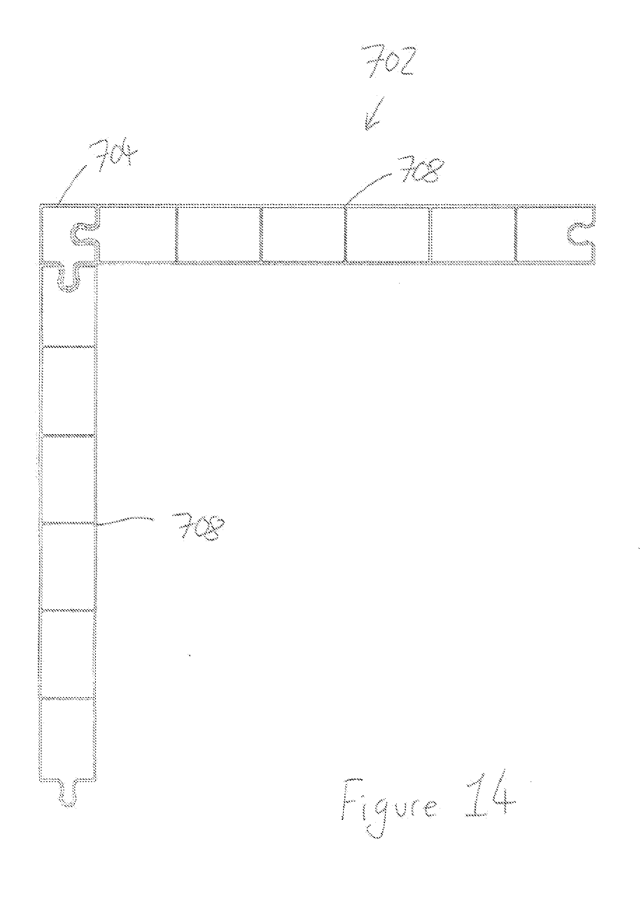

FIG. 14 is a horizontal cross-section through a portion of one embodiment of a partition formed from components of the system of the present invention;

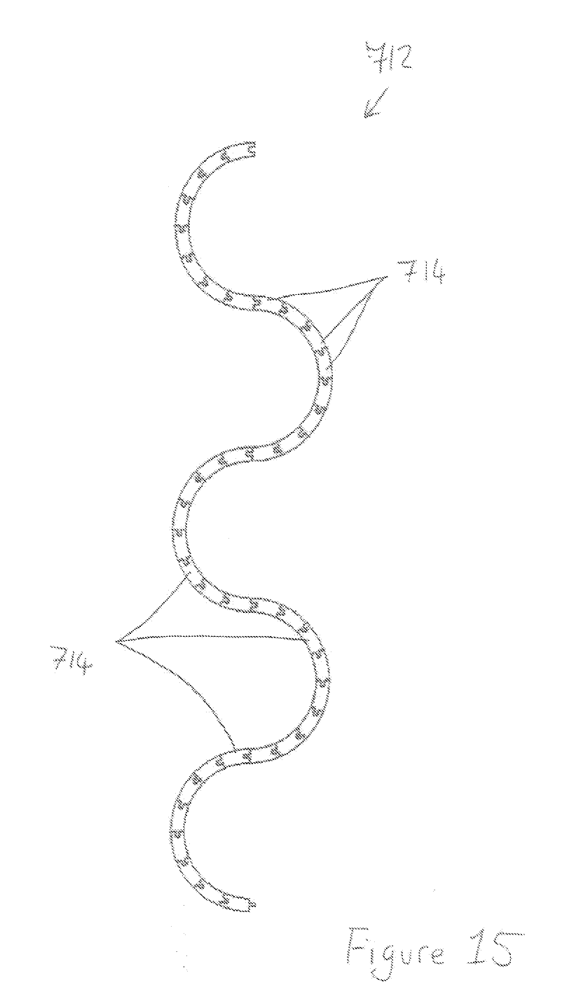

FIG. 15 is a horizontal cross-section through a portion of a second embodiment of a partition formed from components of the system of the present invention;

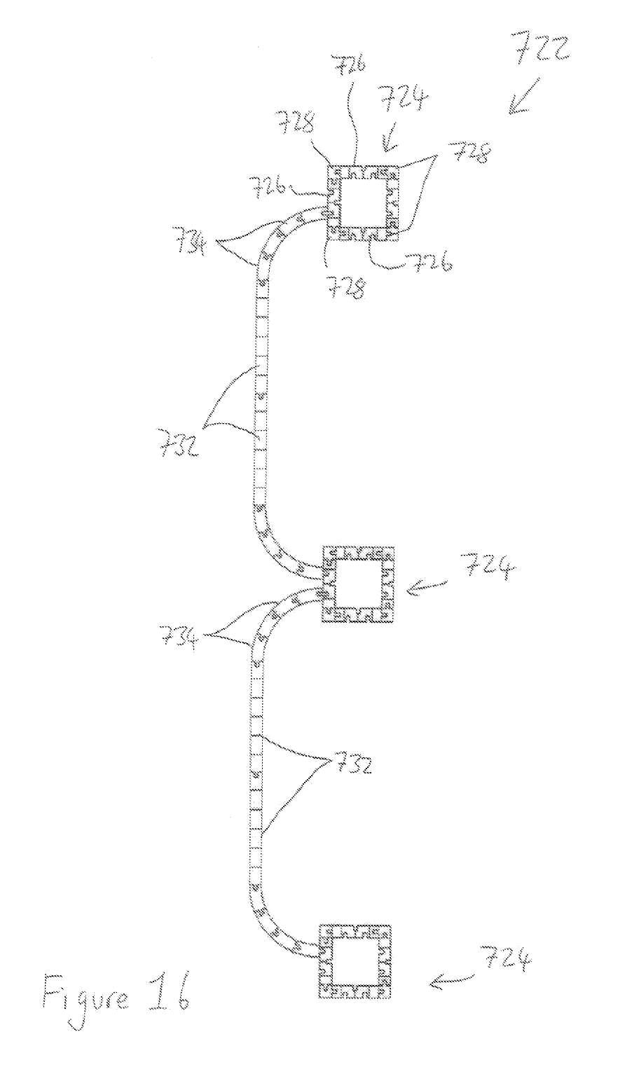

FIG. 16 is a horizontal cross-section through a portion of a third embodiment of a partition formed from components of the system of the present invention;

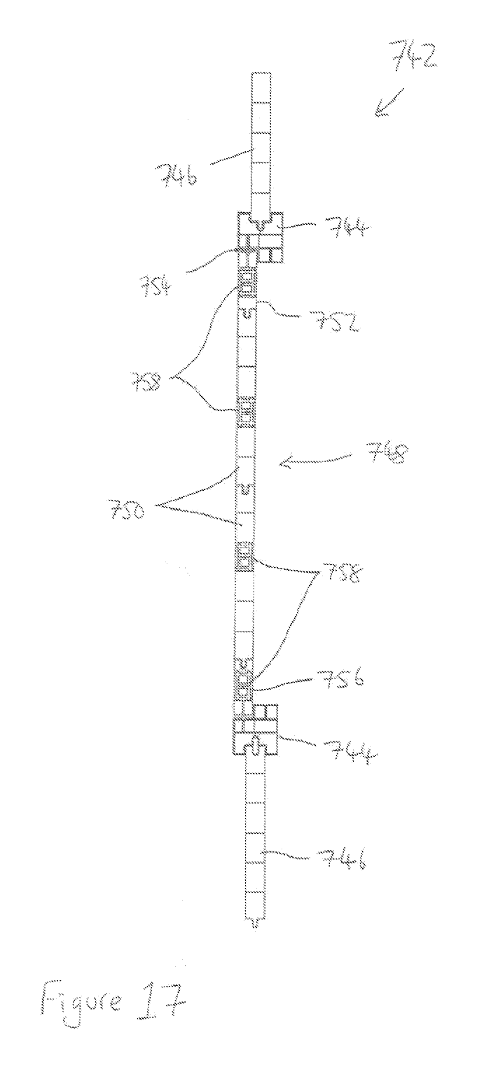

FIG. 17 is a horizontal cross-section through a portion of a fourth embodiment of a partition formed from components of the system of the present invention; and

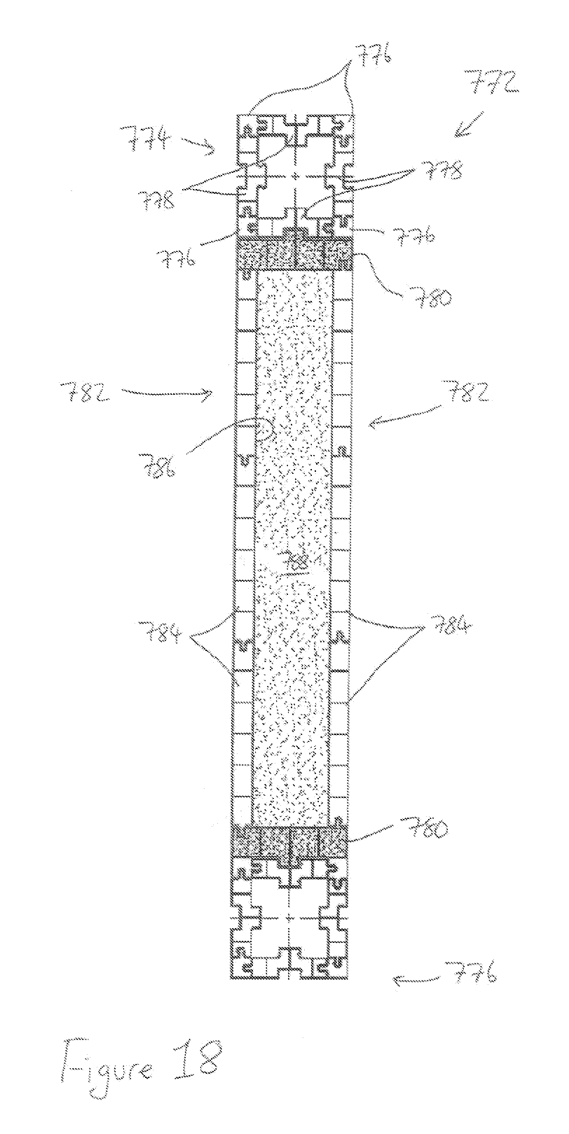

FIG. 18 is a horizontal cross-section through a portion of a fifth embodiment of a partition formed from components of the system of the present invention.

Turning to FIG. 1, there is shown a partition, generally indicated as 2, formed from components of the system of the present invention. The partition 2 comprises a plurality of vertically extending panel components 4, described in more detail below, adjacent panel components being connected by a releasable connection means as described in more detail below. The partition 2 is provided with horizontal trunking components 6, providing a conduit for cables, pipes and the like. The horizontal trunking components 6 are attached to the partition using releasable connection means of the same general kind as used to connect adjacent panel components 4.

A first embodiment of a releasable connection means for connecting adjacent components of the system of the present invention is shown in cross-section in FIG. 2a. The releasable connection means, generally indicated as 102, comprises a male member 104 and a female member 106. The male member 104 is in the form of an elongate tongue formed in and extending from a wall of the component. The distal portion 108 of the male member 104 has a width A. The proximal portion 110 of the male member 104 has a width B. The width A is greater than the width B, as shown in FIG. 2a. The ratio of A to B is about 1:1.25. The female member 106 is in the form of an elongate groove formed in a wall of the component. As shown in FIG. 2a, the female member 106 is formed with an interior form that matches the exterior form of the male member 104, such that the male member is accommodated within the groove of the female member and firmly held.

A second embodiment of a releasable connection means for connecting adjacent components of the system of the present invention is shown in cross-section in FIG. 2b. The releasable connection means, generally indicated as 112, is of the same general form as that shown in FIG. 2a and comprises a male member 114 and a female member 116. The male member 114 is in the form of an elongate tongue formed in and extending from a wall of the component. The distal portion 118 of the male member 114 has a width C. The proximal portion 120 of the male member 114 has a width D. The width C is greater than the width D, as shown in FIG. 2b. The ratio of C to D is about 1:1.07. The female member 116 is in the form of an elongate groove formed in a wall of the component. As shown in FIG. 2b, the female member 116 is formed with an interior form that matches the exterior form of the male member 114, such that the male member is accommodated within the groove of the female member and firmly held.

As shown in FIGS. 2a and 2b, the two releasable connection means 102, 112 are of the same general configuration and operation, but differ in size. In particular, the male member 114 of the embodiment of FIG. 2b is about eight times wider than the male member 104 of the embodiment of FIG. 2a. As will be appreciated, the contact area between the surfaces of the connected male and female members in the connection in FIG. 2b is significantly greater than that of the connection in FIG. 2a, in turn giving the connection in FIG. 2b greater strength and rigidity than that of FIG. 2a.

The connection means shown in FIGS. 2a and 2b are shown as integrally formed with components, in particular as part of an extruded plastic component. Typically, the wall thickness of the components shown in FIGS. 2a and 2b is about 2 mm.

As shown in FIGS. 2a and 2b, the male and female members are formed as integral parts of a component. It will be appreciated that the male and female members may be arranged in opposing pairs to form respective male and female connecting members or mixed male/female connecting members.

Referring to FIG. 3, there is shown a cross-section of one embodiment of a panel component, generally indicated as 202, of the system of the present invention. The panel component 202 is an elongate member formed from plastic by extrusion and comprises two flat, opposing major walls 204, 206 and two opposing minor walls 208, 210, extending perpendicular to and between the opposing major walls. One minor wall 208 is formed to provide a male member 212 of a releasable connection means, of the general type shown in FIG. 2a. The other minor wall 210 is formed to provide a corresponding female member 214 of the connection means shown in FIG. 2a. The interior of the panel component 202 is hollow and empty. Partitions 216 extend across the interior between and perpendicular to the opposing major walls 204, 206.

Referring to FIG. 4, there is shown a cross-section of a further embodiment of a panel component, generally indicated as 222, of the system of the present invention. The panel component 222 is an elongate member formed from plastic by extrusion and comprises two curved, opposing major walls 224, 226 and two opposing minor walls 228, 230, extending perpendicular to and between the opposing major walls. One minor wall 228 is formed to provide a male member 232 of a releasable connection means, of the general type shown in FIG. 2a. The other minor wall 230 is formed to provide a corresponding female member 234 of the connection means shown in FIG. 2a. The interior of the panel component 222 is hollow and empty. The radius of curvature of the major wall 224 is about 165 mm.

Turning to FIG. 5, there is shown a cross-sectional view of a corner post component of the system of the present invention. The corner post component, generally indicated as 252, is an elongate member formed from plastic by extrusion and comprises four, generally flat walls 254, 256, 258 and 260 arranged to form a generally square cross-section. A male member 262 of a releasable connection means, of the general type shown in FIG. 2a is formed in the wall 254. A female member 264 of a releasable connection means, of the general type shown in FIG. 2a is formed in the wall 256, at right angles to the male member 262. The interior of the corner post component is hollow.

Referring to FIG. 6, there is shown a cross-sectional view of one embodiment of a post side component of the system of the present invention. The post side component, generally indicated as 272, is an elongate member formed from plastic by extrusion and comprises two flat, opposing major walls 274, 276 and two opposing minor walls 278, 280, extending perpendicular to and between the opposing major walls. One minor wall 278 is formed to provide a male member 282 of a releasable connection means, of the general type shown in FIG. 2a. The other minor wall 280 is formed to provide a corresponding female member 284 of the connection means shown in FIG. 2a. One major wall 274 is formed to provide a female member 286 of the connection means shown in FIG. 2a, arranged generally centrally in the wall. The second major wall 276 is formed to provide two female members 288 of the connection means shown in FIG. 2a, arranged generally symmetrically about the centre line of the wall. The interior of the panel component 272 is hollow and empty. Partitions 290 extend across the interior between and perpendicular to the opposing major walls 274, 276.

Referring to FIG. 7, there is shown a cross-sectional view of a second embodiment of a post side component of the system of the present invention. The post side component, generally indicated as 292, is an elongate member formed from plastic by extrusion and has the same general configuration as the component shown in FIG. 6. Accordingly, features of the post side component 292 of FIG. 7 in common with the component shown in FIG. 6 are indicated using the same reference numerals and are as described above. In contrast to the component of FIG. 6, however, the first major wall 274 is provided with a single male member 294 of a releasable connection means of the type shown in FIG. 2b. Further, the second major wall 276 is formed to provide a single female member 296 of the general type shown in FIG. 2b.

Turning now to FIG. 8, there is shown a cross-sectional view of a frame component of one embodiment of the present invention. The frame component, generally indicated as 302, is for forming the frame of an opening in the assembled partition, in particular a door opening. Frame components for windows and other openings may be formed in like manner.

The frame component 302 is an elongate member formed from plastic by extrusion and comprises a first wall 304 having formed therein a releasable connection means in the form of a female member 306. As will be seen, the female member 306 is provided with an interior form having a first narrow portion 308 and a second wider portion 310. In this way, the female member 306 is able to accommodate male members of different sizes, thereby that allows a releasable connection of either of FIG. 2a or 2b to be formed. The frame component 302 further comprises a second wall 312 and an opposing third wall 314, each extending perpendicular from respective edges of the first wall 304. The side of the frame component opposing the first wall is formed to provide a recess and jamb to define an opening of largely conventional configuration for receiving a door. Thus, the frame component is provided with perpendicular wall sections 316, 318 and a wall section 320. The wall section 316 may provide a mounting for a hinge or other means (not shown in FIG. 8) to support the door.

As shown in FIG. 8, the interior of the frame component 302 is provided with a plurality of perpendicular partitions 322, dividing the interior of the component into a plurality of generally rectangular compartments and providing strength and rigidity to the component.

A component for forming a door for use in conjunction with the frame component of FIG. 8 is shown in cross-section in FIG. 9. The door component, generally indicated as 332, is an elongate member formed from plastic by extrusion and comprises two flat, opposing major walls 334, 336 and two opposing minor walls 338, 340, extending perpendicular to and between the opposing major walls. One minor wall 338 is formed to provide a male member 342 of a releasable connection means, of the general type shown in FIG. 2a. The other minor wall 340 is formed to provide a mounting for a hinge or other means for supporting the door in the opening in the partition. The interior of the panel component 332 is hollow and empty. Partitions 344 extend across the interior between and perpendicular to the opposing major walls 334, 336.

In use, the door component 332 may be combined with panel components of the type shown in FIG. 3, and described above, to form a door of the required size. It will be appreciated that the male member 342 formed in the minor wall 338 may be replaced by a female member. The door component 332 shown in FIG. 9 is for providing the hinged edge of the door. A corresponding component may be formed for providing the closing edge of the door in very similar manner.

Referring to FIG. 10, there is shown one embodiment of a cavity end component of the system of the present invention. The cavity end component, generally indicated as 402, is an elongate member formed from plastic by extrusion and comprises two flat, opposing major walls 404, 406 and two opposing minor walls 408, 410, extending perpendicular to and between the opposing major walls. One major wall 404 is formed to provide a male member 412 of the connection means shown in FIG. 2b, arranged generally centrally in the wall. The second major wall 406 is formed to provide a male member 414 of the connection means shown in FIG. 2a, arranged in the edge portion of the wall 406 adjacent the minor wall 408. The second major wall 406 is further formed to provide a female member 416 of the connection means shown in FIG. 2a, arranged in the edge portion of the wall 406 adjacent the minor wall 410. The interior of the panel component 402 is hollow and filled with a material 418 to provide thermal and noise insulation. Partitions 420 extend across the interior between and perpendicular to the opposing major walls 404, 406.

Referring to FIG. 11, there is shown a second embodiment of a cavity end component of the system of the present invention. The cavity end component, generally indicated as 432, is an elongate member formed from plastic by extrusion and comprises two flat, opposing major walls 434, 436 and two opposing minor walls 438, 440, extending perpendicular to and between the opposing major walls. One major wall 434 is formed to provide a male member 442 of the connection means shown in FIG. 2a, arranged in the edge portion of the wall 434 adjacent the minor wall 438. The first major wall 434 is further formed to provide a female member 444 of the connection means shown in FIG. 2a, arranged in the edge portion of the wall 434 adjacent the minor wall 440. The second major wall 436 is formed to provide a male member 446 of the connection means shown in FIG. 2a, arranged in the edge portion of the wall 436 adjacent the minor wall 440. The second major wall 436 is further formed to provide a female member 448 of the connection means shown in FIG. 2a, arranged in the edge portion of the wall 436 adjacent the minor wall 438. The interior of the panel component 432 is hollow and filled with a material 450 to provide thermal and noise insulation. Partitions 452 extend across the interior between and perpendicular to the opposing major walls 434, 436.

Turning to FIG. 12 there is shown in cross-section a separate connecting member for use in connecting components of the system of the present invention. The connecting member, generally indicated as 502, comprises a pair of opposing male members 504, 506 for use in connecting with female members formed in components, as described above, and forming a releasable connection of the general type shown in FIG. 2a. The connecting member 502 is an elongate member formed from plastic by extrusion.

A corresponding connecting member for forming a connection of the type shown in FIG. 2b may be provided in analogous manner to the connecting member of FIG. 12.

FIG. 13 shows an extension component, generally indicated as 602, for use in connecting components of the system of the present invention in a longitudinal arrangement, that is end to end. The extension component 602 is formed from extruded plastic and comprises a pair of first spaced apart wall members 604 and a pair of second spaced apart wall members 606 extending between and orthogonally to the first wall members 604. A pair of intermediate wall members 608 are provided to extend parallel to the first wall members 604 between the centres of the second wall members 606. In use, the extension component 602 is inserted partially or wholly into the interior of a component. The extension component 602 is an interference fit within the interior, with the ends of the wall members 604, 606 bearing against the inner surfaces of the outer walls of the component. The extension component may be used in this manner to connect components end to end, for example to increase the height of a partition. Alternatively, the extension component may be inserted into a component to increase its strength and rigidity.

FIGS. 14 to 18 show horizontal cross-sectional views of different embodiments of partitions formed using the components of the system of the present invention described above.

Thus, FIG. 14 shows a corner portion of a partition, generally indicated as 702. The corner portion is formed from a corner post component 704, of the type shown in FIG. 5, connected to two panel components 706, 708, of the type shown in FIG. 3, extending perpendicular to one another.

FIG. 15 shows a portion of a partition, generally indicated as 712, formed from a plurality of panel components 714 of the type shown in FIG. 4.

FIG. 16 shows a portion of a partition, generally indicated as 722. The partition 722 comprises a plurality of post assemblies 724, each post assembly formed from four post side components 726 of the type shown in FIG. 6 and four corner post components 728 of the type shown in FIG. 5. A wall portion 730 extends between adjacent post assemblies 724, each wall portion formed from a combination of panel components 732, 734 of the types shown in FIGS. 3 and 4.

FIG. 17 shows a portion of a partition, generally indicated as 742. The partition 742 comprises a pair of frame components 744 of the type shown in FIG. 8 defining a door opening. Panel components 746 of the type shown in FIG. 3 extend from each from component 744 to form wall portions. A door, generally indicated as 748, is supported within the door opening and is formed from a plurality of panel components 750 of the type shown in FIG. 3. A component 752 of the type shown in FIG. 9 forms one vertical edge of the door 748 and is connected to the adjacent frame component 744 by a hinge 754. The other vertical edge of the door 748 is formed from a similar component 756. To provide additional strength to the door 748, extension components 758 of the general type shown in FIG. 13 have been inserted into the components 750, 752, 756 making up the door.

FIG. 18 shows a portion of a partition, generally indicated as 772, formed with a cavity. The partition 772 comprises two post assemblies 774, each formed from four corner post components 776 of the type shown in FIG. 5 and four post side components 778 of the type shown in FIG. 7. Each post assembly 774 is provided with a cavity end component 780 of the type shown in FIG. 10, such that the cavity end components 780 extend across opposing sides of the post assemblies. A pair of parallel, spaced apart wall portions 782 are formed from panel components 784 of the type shown in FIG. 3 and extend between the opposing cavity end components 780 and define a cavity 786 therebetween. The cavity 786 is filled with an insulation material 788.

1. A temporary partitioning system, the system comprising a plurality of partition components, each component being an elongate member having outer walls enclosing a substantially hollow interior and having a longitudinal axis, each component being releasably connectable to an adjacent member by a connection means, the connection means comprising a first connection member provided on a first component and a second connection member provided on a second component, in use the first and second connecting members connecting such that lateral movement between the first and second components is prevented, while allowing the first component to move along its longitudinal axis relative to the second component.

2. The system according to claim 1, wherein the ends of the components are open.

3. The system according to claim 1, wherein the components are formed by extrusion.

4. The system according to claim 1, wherein the components are of plastic.

5. The system according to claim 4, wherein at least a portion of the plastic is recycled.

6. The system according to claim 1, wherein the first connecting member is a male member and the second connecting member is a female member arranged to receive and hold the male member.

7. The system according to claim 6, wherein the male member comprises a distal portion and a proximal portion, the distal portion being wider than the proximal portion, the female member having an opening that is narrower than the width of the distal portion of the male member.

8. The system according to claim 6, wherein the male member is longitudinally extending tongue.

9. The system according to claim 6, wherein the female member is a longitudinally extending groove.

10. The system according to claim 1, wherein two components may be connected by a single connection means.

11. The system according to claim 10, wherein the single connection means extends substantially the entire length of the component.

12. The system according to claim 1, wherein one or both of the first and second connecting members are resilient to provide a biasing force, the members when connected being held at least partially by the biasing force.

13. The system according to claim 1, wherein the components are provided with releasable connection means of a first larger dimension and a second smaller dimension.

14. The system according to claim 13, wherein the system comprises second connecting members that can accommodate first connecting members of both the first and second dimensions.

15. The system according to claim 1, wherein first and/or second connecting members are integrally formed with the components.

16. The system according to claim 1, wherein first and/or connecting members are provided separately from the components.

17. The system according to claim 1, wherein components are provided with partitions extending across their interior.

18. The system according to claim 17, wherein the partitions extend perpendicular to the outer walls of the components.

19. The system according to claim 1, wherein the components are panel components, having a pair of opposing major walls and a pair of opposing minor walls extending between the opposing major walls, one or both minor walls being provided with either a first connecting member or a second connecting member.

20. The system according to claim 19, wherein the major walls are flat.

21. The system according to claim 19, wherein the major walls are arcuate

22. The system according to claim 1, wherein the components are corner post components, having a first outer wall and a second outer wall extending at an angle to the first outer wall, each first and second outer wall being provided with either a first or a second connecting member.

23. The system according to claim 22, wherein the first and second outer walls are adjacent.

24. The system according to claim 22, wherein the second outer wall is perpendicular to the first outer wall.

25. The system according to claim 1, wherein the components are post side components, having a pair of opposing major walls and a pair of opposing minor walls extending between the opposing major walls, each of the minor walls being provided with either a first or second connecting member and at least one of the major walls being provided with either a first or a second connecting member.

26. The system according to claim 1, wherein the components are frame components, having a first outer wall provided with either a first or a second connecting member and a second outer wall, opposing the first and, in use, defining an opening in the partition.

27. The system according to claim 1, wherein the components are cavity end components, having a pair of opposing major walls and a pair of opposing minor walls extending between the opposing major walls, one of the major walls being provided with either a first or second connecting member at each of two spaced apart locations on the wall and the other of the major walls being provided with either a first or a second connecting member.

28. The system according to claim 1, further comprising an extension component for insertion into a component.

29. The system according to claim 28, wherein the extension component comprises members to contact and bear on the inner surfaces of the walls of the component into which it is inserted.

30. The system according to claim 29, wherein the extension component is an interference fit within the component.
